(19) United States
(12) Patent Application Publication
(10) Pub. No.: US 2020/0004503 A1
(43) Pub. Date: Jan. 2, 2020

(54) INFORMATION PROCESSING DEVICE, INFORMATION PROCESSING METHOD, AND COMPUTER READABLE MEDIUM

(71) Applicant: Mitsubishi Electric Corporation, Tokyo (JP)

(72) Inventors: Tomomi TAKEUCHI, Tokyo (JP); Masahiro FUNATSUKI, Tokyo (JP); Noriyuki MINEGISHI, Tokyo (JP)

(73) Assignee: Mitsubishi Electric Corporation, Tokyo (JP)

(21) Appl. No.: 16/481,386

(22) PCT Filed: Mar. 17, 2017
(86) PCT No.: PCT/JP2017/010856

§ 371 Date: Jul. 26, 2019

(51) Int. Cl. G06F 7/57; G06F 13/40

(52) U.S. Cl. CPC G06F 7/57; G06F 13/4027

(57) ABSTRACT

A database stores interface transfer capacity information in which calculation formulas for calculation of a data transfer capacity are described, correspondingly to types of interface circuits. A transfer time evaluation unit acquires a calculation formula corresponding to a type of a specified interface circuit which has been specified from among a plurality of interface circuits as an interface circuit to connect a plurality of arithmetic operational devices among which execution of a plurality of arithmetic operation processes is divided, from the interface transfer capacity information, and calculates the data transfer capacity of the specified interface circuit by using the acquired calculation formula.

### TECHNICAL FIELD

The present invention relates to an information processing device, an information processing method, and an information processing program.

### BACKGROUND ART

In design of an embedded system, for instance, components are selected so as to satisfy constraint conditions (such as performance, sizes, and costs) required for the embedded system. Then arithmetic operation processes required for the embedded system are allocated to the components. In general, arithmetic operation processes whose arithmetic operation process amounts are so large as to impair performance of components are allocated to hardware or processors that are capable of high-speed processing for software. The hardware is FPGA (Field-Programmable Gate Array) or ASIC (Application Specific Integrated Circuit), for instance. The processors that are capable of the high-speed processing for software are DSP (Digital Signal Processor), GPU (Graphics Processing Unit), or the like, for instance. Sequential processing, overall control, and the like are allocated to processors of other types. The sequential processing, the overall control, and the like are allocated to CPU (Central Processing Unit), for instance.

In such a case where holddown on the costs is demanded with top priority in accordance with the constraint conditions, however, the arithmetic operation processes whose arithmetic operation process amounts are large may be allocated to CPUs not supporting high-speed interface circuits. In such a case, allocation of the arithmetic operation processes may not be decided based only on the arithmetic operation process amounts. That is, it is necessary to consider data transfer capacities of the interface circuits for the allocation of the arithmetic operation processes in such a case.

Patent Literature 1 discloses a technique of evaluating influence of an interface circuit to pass data between hardware and processors to execute software.

In the technique of Patent Literature 1, more specifically, interface circuit information indicating latency and protocol types (handshake type or cue type) of arithmetic operational devices (hardware or processor) connected to the interface circuit is read in. In the technique of Patent Literature 1, time taken until obtainment of a result from the arithmetic operational devices to which the interface circuit is connected and a data input cycle are generated as model information and whether or not partition between the hardware and the software satisfies the constraints is checked.

### CITATION LIST

### Patent Literature

Patent Literature 1: JP 2000-57199 A

### SUMMARY OF INVENTION

### Technical Problem

Data transfer performance of interface circuits changes depending on types and register settings of CPU or the like to be connected, for each type of the interface circuits. Therefore, the information on the latency of an arithmetic operational device to be connected and on whether the protocol type thereof is the handshake type or the cue type is insufficient. That is, in order to calculate the data transfer capacity of the an interface circuit, it is necessary to change the interface circuit information for each type of the interface circuit and it is necessary for a user to provide information required for calculation of the data transfer capacity of the interface circuit, for each type of the interface circuit.

Thus Patent Literature 1 has a problem of insufficient convenience because the user has to set the information for the calculation of the transfer capacity of the interface circuit for each type of the interface circuit.

The present invention mainly aims at solving such a problem. More specifically, the present invention mainly aims at obtaining a configuration by which the transfer capacity of an interface circuit can be calculated without setting by the user for each type of the interface circuit.

### Solution to Problem

An information processing device according to the present invention includes:

a storage unit to store interface transfer capacity information in which calculation formulas for calculation of a data transfer capacity are described, correspondingly to types of interface circuits; and

a transfer capacity calculation unit to acquire a calculation formula corresponding to a type of a specified interface circuit which has been specified from among a plurality of interface circuits as an interface circuit to connect a plurality of arithmetic operational devices among which execution of a plurality of arithmetic operation processes is divided, from the interface transfer capacity information, and to calculate the data transfer capacity of the specified interface circuit by using the acquired calculation formula.

### Advantageous Effects of Invention

According to the present invention, the transfer capacity of an interface circuit can be calculated without the setting by the user for each type of the interface circuit.

### BRIEF DESCRIPTION OF DRAWINGS

FIG. 1 is a diagram illustrating a functional configuration example of an information processing device according to Embodiment 1.

FIG. 2 is a diagram illustrating a description example of architecture information according to Embodiment 1.

FIG. 3 is a diagram illustrating a behavioral description example of a functional model according to Embodiment 1.

FIG. 4 is a diagram illustrating a description example of a constraint condition according to Embodiment 1.

FIG. 5 is a diagram illustrating an example of interface transfer capacity information according to Embodiment 1.

FIG. 6 is a diagram illustrating a description example of partition final candidates according to Embodiment 1.

FIG. 7 is a diagram illustrating a hardware configuration example of the information processing device according to Embodiment 1.

FIG. 8 is a flowchart illustrating an example of operation of the information processing device according to Embodiment 1.

### DESCRIPTION OF EMBODIMENTS

Hereinbelow, an embodiment of the invention will be described with use of the drawings. In following description on the embodiment and the drawings, elements provided with identical reference characters represent identical parts or corresponding parts.

### Embodiment 1

***Description of Configuration***

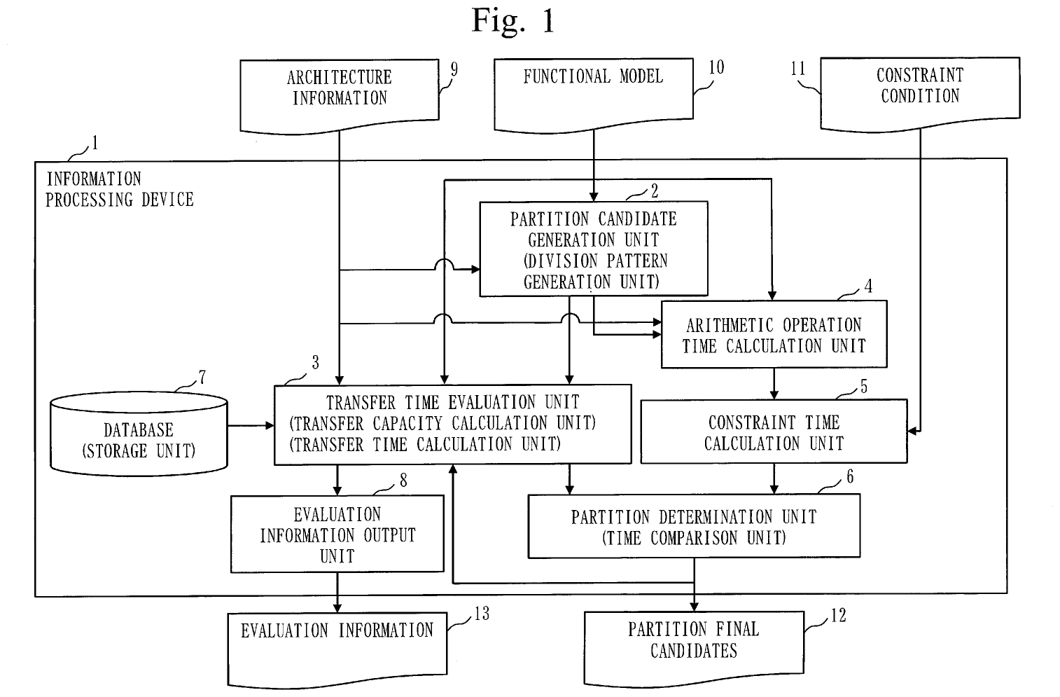

FIG. 1 illustrates a functional configuration example of an information processing device 1 according to the present embodiment.

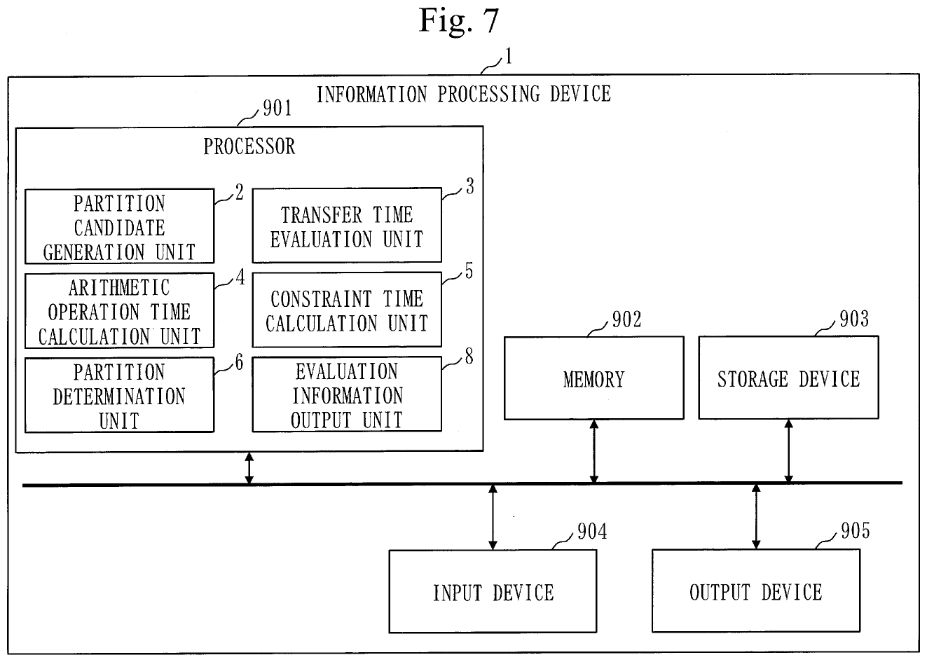

FIG. 7 illustrates a hardware configuration example of the information processing device 1 according to the embodiment.

Operation that is carried out by the information processing device 1 corresponds to an information processing method and an information processing program.

With reference to FIG. 7, initially, the hardware configuration example of the information processing device 1 will be described.

The information processing device 1 according to the embodiment is a computer.

The information processing device 1 includes a processor 901, a memory 902, a storage device 903, an input device 904, and an output device 905, as hardware.

Programs to implement functions of a partition candidate generation unit 2, a transfer time evaluation unit 3, an arithmetic operation time calculation unit 4, a constraint time calculation unit 5, a partition decision unit 6, and an evaluation information output unit 8 that are illustrated in FIG. 1 are stored in the storage device 903.

The programs are loaded from the storage device 903 into the memory 902. Then the processor 901 then reads out the programs from the memory 902. By executing the programs, the processor 901 carries out operation of the partition candidate generation unit 2, the transfer time evaluation unit 3, the arithmetic operation time calculation unit 4, the constraint time calculation unit 5, the partition decision unit 6, and the evaluation information output unit 8 to be described later.

FIG. 7 schematically illustrates a state in which the processor 901 executes the programs to implement the functions of the partition candidate generation unit 2, the transfer time evaluation unit 3, the arithmetic operation time calculation unit 4, the constraint time calculation unit 5, the partition decision unit 6, and the evaluation information output unit 8.

The storage device 903 configures a database 7 illustrated in FIG. 1. That is, the storage device 903 stores interface transfer capacity information.

The input device 904 is used for input of architecture information 9, a functional model 10, and a constraint condition 11 that are to be described later.

The interface transfer capacity information in the storage device 903 may be rewritten through the input device 904 such as a keyboard. The interface transfer capacity information may be replaced by using a USB (Universal Serial Bus) memory or the like.

The output device 905 outputs partition final candidates 12 and evaluation information 13 that are to be described later.

With reference to FIG. 1, subsequently, the functional configuration example of the information processing device 1 will be described.

The information processing device 1 is composed of the partition candidate generation unit 2, the transfer time evaluation unit 3, the arithmetic operation time calculation unit 4, the constraint time calculation unit 5, the partition decision unit 6, the database 7, and the evaluation information output unit 8.

The partition candidate generation unit 2 acquires the architecture information 9 and the functional model 10.

The functional model 10 is a program described in a program description language such as C or C++. A plurality of arithmetic operation processes are included in the functional model 10.

In the architecture information 9, types, connection relation, and the like of arithmetic operational devices, memories, and interface circuits that are included in a system (such as an embedded system) to execute the functional model 10 are described. In the arithmetic operational devices, hardware such as FPGA or ASIC and processors such as DSP, GPU, and CPU to execute software are included.

With reference to the architecture information 9, the partition candidate generation unit 2 generates partition candidates as to which arithmetic operation processes in the functional model 10 are to be allocated to the software or to the hardware. That is, the partition candidate generation unit 2 generates a plurality of division patterns of the plurality of arithmetic operation processes among the plurality of arithmetic operational devices through hardware/software partition. The division patterns generated by the partition candidate generation unit 2 will be referred to as partition candidates, hereinbelow.

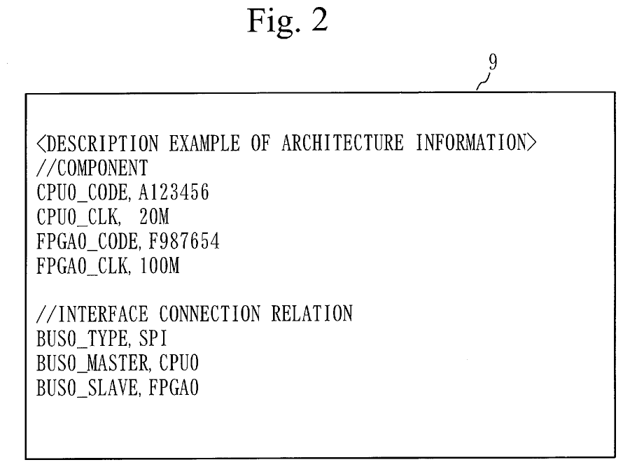

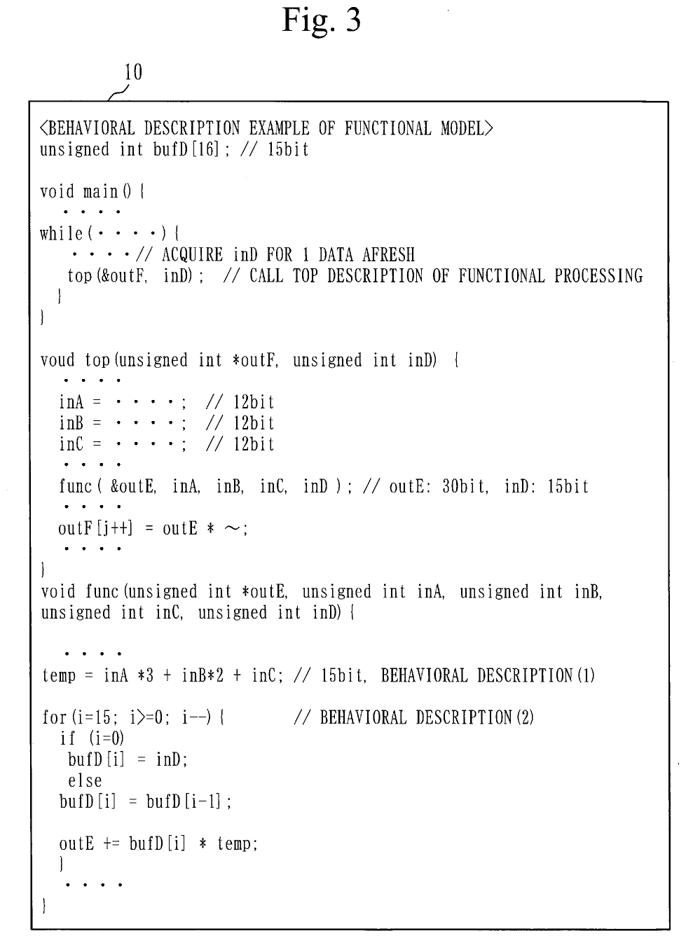

FIG. 2 illustrates a description example of the architecture information 9. FIG. 3 illustrates a behavioral description example of the functional model 10.

Details of FIGS. 2 and 3 will be described later.

The partition candidate generation unit 2 corresponds to a division pattern generation unit.

The transfer time evaluation unit 3 acquires the interface transfer capacity information from the database 7.

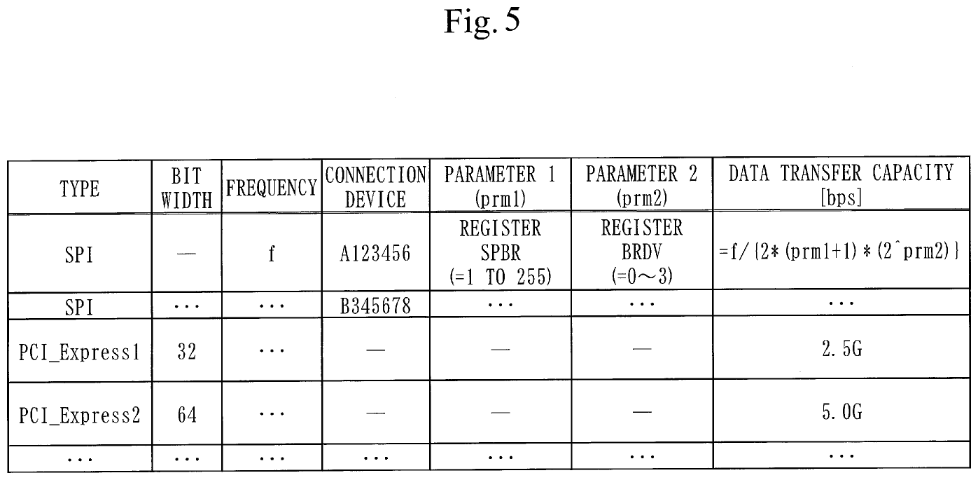

FIG. 5 illustrates an example of the interface transfer capacity information. Though details of FIG. 5 will be described later, in the interface transfer capacity information, calculation formulas for calculation of the data transfer capacity are described, correspondingly to combinations of the types of the interface circuit and the types of the arithmetic operational devices.

The transfer time evaluation unit 3 acquires a calculation formula corresponding to a combination of the type of the interface circuit and the type of the arithmetic operational device that are specified in the architecture information 9, from the interface transfer capacity information. The interface circuit specified in the architecture information 9 will be referred to as a specified interface circuit.

The transfer time evaluation unit 3 calculates the data transfer capacity of the specified interface circuit by using the acquired calculation formula for the specified interface circuit.

The transfer time evaluation unit 3 estimates an amount of data that is transferred among the plurality of arithmetic operational devices when execution of the plurality of arithmetic operation processes is divided among the plurality of arithmetic operational devices, for each partition candidate. The transfer time evaluation unit 3 further calculates data transfer time for transfer of the estimated amount of data through the specified interface circuit for each partition candidate, based on the calculated transfer capacity of the specified interface circuit.

The transfer time evaluation unit 3 corresponds to a transfer capacity calculation unit and a transfer time calculation unit.

The arithmetic operation time calculation unit 4 calculates arithmetic operation time in each of the plurality of arithmetic operational devices for each partition candidate.

The constraint time calculation unit 5 acquires the constraint condition 11. Overall required performance is described in the constraint condition 11.

Processing time required for the system which executes the functional model 10 is described in the overall required performance.

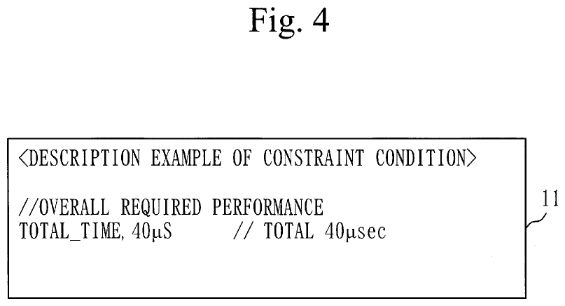

FIG. 4 illustrates a description example of the constraint condition 11. Details of FIG. 4 will be described later.

The constraint time calculation unit 5 calculates constraint time for data transfer by subtracting the arithmetic operation time calculated by the arithmetic operation time calculation unit 4 from the overall required performance described in the constraint condition 11, for each partition candidate.

The partition decision unit 6 compares the data transfer time for the partition candidate calculated by the transfer time evaluation unit 3, with the constraint time calculated by the constraint time calculation unit 5.

The partition decision unit 6 corresponds to a time comparison unit.

The database 7 stores the interface transfer capacity information.

The database 7 corresponds to a storage unit.

***Description of Operation***

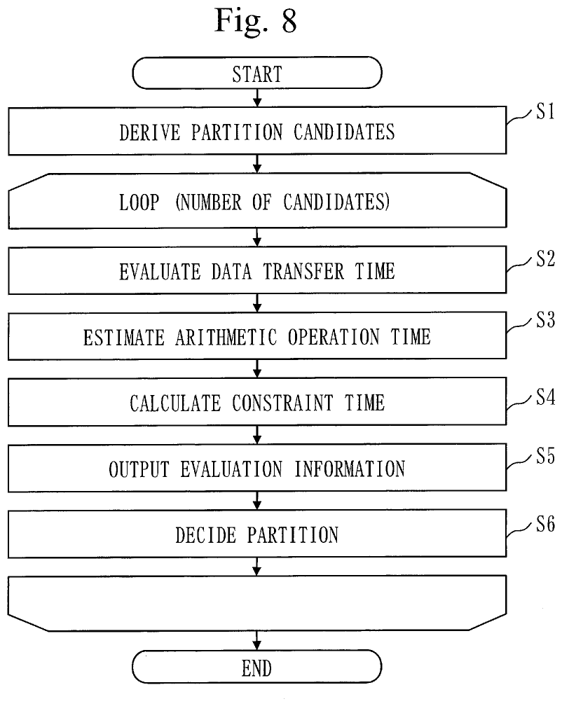

With reference to FIG. 8, subsequently, an example of operation of the information processing device 1 according to the embodiment will be described.

Initially, a partition candidate generation step (step S1) will be described.

In the partition candidate generation step (step S1), the partition candidate generation unit 2 generates the partition candidates based on the architecture information 9. That is, the partition candidate generation unit 2 generates a plurality of combinations of the arithmetic operation processes to be allocated to the software and the arithmetic operation processes to be allocated to the hardware. The combinations of the arithmetic operation processes to be allocated to the software and the arithmetic operation processes to be allocated to the hardware correspond to the partition candidates.

The partition candidate generation unit 2 may generate all the conceivable combinations as the partition candidates or may empirically generate a specified number of partition candidates based on a database or the like.

The partition candidate generation unit 2 partitions the functional model 10 in units of function, for instance. The partition candidate generation unit 2 may partition the functional model 10 not only in the units of function but with use of loops of for statement or the like expanded from functions as partition units.

Subsequently, a data transfer time evaluation step (step S2) will be described.

In the data transfer time evaluation step (step S2), the transfer time evaluation unit 3 identifies the interface circuit included in the system which executes the functional model 10, with reference to the architecture information 9. The interface circuit identified by the transfer time evaluation unit 3 corresponds to the specified interface circuit. The transfer time evaluation unit 3 identifies the arithmetic operational device included in the system which executes the functional model 10, with reference to the architecture information 9.

The transfer time evaluation unit 3 further refers to the interface transfer capacity information stored in the database 7. The transfer time evaluation unit 3 acquires a calculation formula corresponding to a combination of the type of the specified interface circuit and the type of the arithmetic operational device from the interface transfer capacity information. The transfer time evaluation unit 3 then calculates the data transfer capacity of the specified interface circuit by using the acquired calculation formula.

The transfer time evaluation unit 3 finds out a route of an interface device through which input and output variables at each partition point pass, by using the functional model 10, for the partition candidates acquired from the partition candidate generation unit 2. The transfer time evaluation unit 3 then calculates total number of transfer bits of all the variables that pass through the interface device. The partition point is a block of program codes obtained by partition of the functional model 10. The transfer time evaluation unit 3 further calculates the data transfer time of the specified interface circuit for each partition candidate, from the data transfer capacity of the specified interface circuit and the total number of transfer bits. The transfer time evaluation unit 3 outputs conditions used for calculation of the data transfer time of the specified interface circuit.

Subsequently, an arithmetic operation time estimation step (step S3) will be described.

In the arithmetic operation time estimation step (step S3), the arithmetic operation time calculation unit 4 estimates processing time for each arithmetic operation process in the partition candidates acquired from the partition candidate generation unit 2, as the arithmetic operation time, based on the functional model 10 and the architecture information 9. The time required for the data transfer is not included in the arithmetic operation time. The arithmetic operation time calculation unit 4 statically estimates the arithmetic operation time for each arithmetic operation process by analyzing the description of the functional model 10 and querying the database 7 or the like, for instance. The arithmetic operation time calculation unit 4 may dynamically estimate the arithmetic operation time for the arithmetic operation process by doing a simulation by using the functional model 10.

Subsequently, a constraint time calculation step (step S4) will be described.

In the constraint time calculation step (step S4), the constraint time calculation unit 5 calculates the constraint time for the data transfer by subtracting the arithmetic operation time estimated by the arithmetic operation time calculation unit 4 from the overall required performance indicated in the constraint condition 11, for the route of each variable in the partition candidates acquired from the partition candidate generation unit 2.

Subsequently, an evaluation information output step (step S5) will be described.

In the evaluation information output step (step S5), the evaluation information output unit 8 outputs the evaluation information 13.

In the evaluation information 13, evaluation conditions used for the evaluation of the data transfer time by the transfer time evaluation unit 3, evaluation results, and the like are included.

Subsequently, a partition determination step (step S6) will be described.

In the partition decision step (step S6), the partition decision unit 6 compares the data transfer time for a partition candidate calculated by the transfer time evaluation unit 3, with the constraint time calculated by the constraint time calculation unit 5. If the data transfer time exceeds the constraint time, the partition decision unit 6 notifies the transfer time evaluation unit 3 of a degree by which the data transfer time exceeds the constraint time.

When notified by the partition decision unit 6 that the data transfer time exceeds the constraint time, the transfer time evaluation unit 3 explores whether the constraint time may be satisfied or not by change in settings of the specified interface circuit for the same partition candidate.

That is, if transfer capacity definition information on the specified interface circuit is a calculation formula as in a first line in FIG. 5, the transfer time evaluation unit 3 applies parameter values (to be referred to as alternative parameter values, hereinbelow) that are different from parameter values used for the previous calculation of the data transfer capacity, to the calculation formula. As a result, the transfer time evaluation unit 3 acquires a new data transfer capacity as the data transfer capacity of the specified interface circuit. Hereinbelow, this new data transfer capacity will be referred to as alternative data transfer capacity. The transfer time evaluation unit 3 then calculates data transfer time based on the alternative data transfer capacity.

If the calculated data transfer time based on the alternative data transfer capacity is equal to or shorter than the constraint time, the transfer time evaluation unit 3 notifies the partition decision unit 6 of the data transfer time.

If the calculated data transfer time based on the alternative data transfer capacity exceeds the constraint time, the transfer time evaluation unit 3 further applies different parameters to the calculation formula and thereby acquires another alternative data transfer capacity. The transfer time evaluation unit 3 calculates data transfer time based on another alternative data transfer capacity. If the data transfer time that is equal to or shorter than the constraint time has not been acquired, the transfer time evaluation unit 3 notifies the partition decision unit 6 of the shortest data transfer time among a plurality of calculated data transfer times.

The partition decision unit 6 leaves a partition candidate whose data transfer time is equal to or shorter than the constraint time, as one of the partition final candidates.

The partition decision unit 6 excludes a partition candidate whose data transfer time exceeds the constraint time, from the partition final candidates. The partition decision unit 6 may output all the partition candidates that are left finally, as the partition final candidates 12 or may output only a partition candidate whose data transfer time is the shortest, as the partition final candidates 12.

### Partition Procedure Example 1

With use of FIGS. 2, 3, 4, and 5, subsequently, a procedure through which the information processing device 1 according to the embodiment acquires the partition final candidates 12 will be described.

As described above, FIG. 2 is the description example of the architecture information 9.

FIG. 3 is the behavioral description example of the functional model 10.

FIG. 4 is the description example of the constraint condition 11.

FIG. 5 is the example of the interface transfer capacity information stored in the database 7.

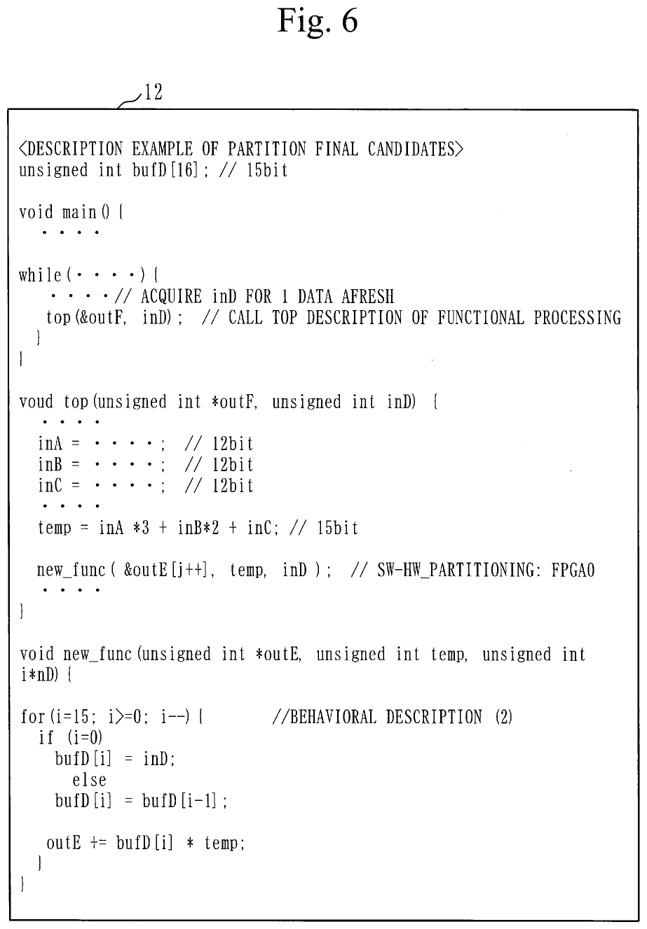

FIG. 6 is a description example of the partition final candidates 12 acquired by the information processing device 1.

In the architecture information 9 of FIG. 2, it is indicated that the system to execute the functional model 10 includes CPU0 (model number: A123456) and FPGAO (model number: 987654). In the architecture information 9 of FIG. 2, it is also indicated that CPU0 operates at 20 MHz. In the architecture information 9 of FIG. 2, it is also indicated that FPGAO operates at 100 MHz. In the architecture information 9 of FIG. 2, it is also indicated that the interface circuit connecting CPU0 and FPGAO is BUS0. In the architecture information 9 of FIG. 2, it is also indicated that BUS0 is SPI (Serial Peripheral Interface). BUS0 corresponds to the specified interface circuit.

In the constraint condition 11 of FIG. 4, it is indicated that execution time for the functional model 10, that is, processing performance of the system to execute the functional model 10 is 40 μsec.

In the interface transfer capacity information of FIG. 5, setting conditions and the data transfer capacity are indicated for each type of the interface circuit.

In FIG. 5, values described in sections of bit width, frequency, connection device, parameter 1 (prm1), and parameter 2 (prm2) are the setting conditions. In sections of the data transfer capacity, calculation formulas for the calculation of the data transfer capacity or values of the data transfer capacity are indicated. In the first line in FIG. 5, the calculation formula for the calculation of the data transfer capacity is described, correspondingly to a combination of the type (SPI) of the interface circuit and the type (model number: A123456) of the arithmetic operational device.

When receiving input of the architecture information 9 of FIG. 2, the constraint condition 11 of FIG. 4, and the functional model 10 of FIG. 3, the partition candidate generation unit 2 generates the partition candidates for the functional model 10. That is, the partition candidate generation unit 2 generates a plurality of candidates for a combination of blocks to be executed by CPU0 and blocks to be executed by FPGAO.

For instance, the partition candidate generation unit 2 generates a partition candidate 1 in which FPGAO executes an entire function func( ) in a function top( ) that is a top description of the behavioral description. The partition candidate generation unit 2 further generates a partition candidate 2 in which FPGAO executes only for statements of behavioral description (2) in the function func( ).

With reference to the architecture information 9 of FIG. 2, the transfer time evaluation unit 3 recognizes that the type of BUS0 that is the interface circuit between CPU0 and FPGAO is SPI. For a reason that the model number of CPU0 is A123456, the transfer time evaluation unit 3 acquires the calculation formula described in the section of the data transfer capacity of SPI in the first line in FIG. 5, from the interface transfer capacity information. That is, the transfer time evaluation unit 3 acquires “=f/{2*(prm1+1)*(2\hat{ }prm2)}”.

Assuming that the frequency f=20 MHz, prm1=3, and prm2=0 are given, the transfer time evaluation unit 3 acquires 20 MHz/{2*(3+1)*2\hat{ }0=2.5 Mbps as the data transfer capacity of BUS0 (SPI).

Subsequently, the transfer time evaluation unit 3 individually evaluates the data transfer time for the partition candidate 1 and the partition candidate 2 that are generated by the partition candidate generation unit 2.

(Evaluation of Data Transfer Time for Partition Candidate 1)

In the partition candidate 1, since the entire function func is made into the hardware, the input and output variables for the hardware are outE, inA, inB, inC, and inD. In order to execute the function func one time, it is necessary to make a transfer of total number of bits=81 bits consisting of outE=30 bits, inA=12 bits, inB=12 bits, inC=12 bits, and inD=15 bits, between CPU0 and FGPA0 through BUS0 (SPI). When execution of the functional model 10 is divided between CPU0 and FPGAO in accordance with the partition candidate 1, the transfer time evaluation unit 3 estimates that data of 81 bits is to be transferred from CPU0 to FPGAO. The data transfer capacity of SPI is 2.5 Mbps and thus the transfer time evaluation unit 3 acquires the following data transfer time.

81 bits/2.5 Mbps=32.4 μsec

(Evaluation of Data Transfer Time for Partition Candidate 2)

In the partition candidate 2, since the behavioral description (2) is made into the hardware, the input and output variables for the hardware are outE, inD, and temp. In order to execute the behavioral description (2) one time, it is necessary to make a transfer of the total number of bits=60 bits consisting of inD=15 bits, temp=15 bits, and outE=30 bits, between CPU0 and FGPA0 through SPI. When the execution of the functional model 10 is divided between CPU0 and FPGAO in accordance with the partition candidate 2, the transfer time evaluation unit 3 estimates that data of 60 bits is to be transferred from CPU0 to FPGAO. The data transfer capacity of SPI is 2.5 Mbps and thus the transfer time evaluation unit 3 acquires the following data transfer time.

60 bits/2.5 Mbps=24.0 μsec

Subsequently, the arithmetic operation time calculation unit 4 calculates the arithmetic operation time for each of the partition candidate 1 and the partition candidate 2.

Herein, only estimation of the arithmetic operation time for the behavioral description (1) will be described because the partition candidate 1 and the partition candidate 2 differ only as to whether a portion of the behavioral description (1) is executed by the hardware or executed by the software; however, the arithmetic operation time calculation unit 4 actually estimates the arithmetic operation time for all portions of the functional model 10.

(Estimation of Arithmetic Operation Time for Partition Candidate 1)

The number of cycles for execution of the behavioral description (1) by the hardware is one cycle. Then FPGAO operates at 100 MHz. Therefore, the arithmetic operation time calculation unit 4 acquires 10 nsec as the arithmetic operation time for the behavioral description (1) of the partition candidate 1.

(Estimation of Arithmetic Operation Time for Partition Candidate 2)

The number of cycles for execution of the behavioral description (1) by the software is four cycles. Then CPU0 operates at 20 MHz. Therefore, the arithmetic operation time calculation unit 4 acquires 50 nsec*4=200 nsec as the arithmetic operation time for the behavioral description (1) of the partition candidate 2.

Other portions of the functional model 10 are supposed to take 32 μsec in total of the software and the hardware, in common between the partition candidate 1 and the partition candidate 2.

Based on the constraint condition 11 specifying that the total processing time is 40 μsec, the constraint time calculation unit 5 subsequently calculates the constraint time for the data transfer for each partition candidate as follows.

(Constraint Time for Partition Candidate 1)

40 μsec−(32 μsec+10 nsec)=7.99 μsec

(Constraint Time for Partition Candidate 2)

40 μsec−(32 μsec+200 nsec)=7.80 μsec

Subsequently, the partition decision unit 6 compares the data transfer time calculated by the transfer time evaluation unit 3, with the constraint time calculated by the constraint time calculation unit 5. Then the partition decision unit 6 determines whether the data transfer time for each partition candidate is equal to or shorter than the constraint time or not.

The data transfer time and the constraint time for the partition candidate 1 and the data transfer time and the constraint time for the partition candidate 2 are as follows.

Data transfer time for partition candidate 1=32.4 μsec

Constraint time for partition candidate 1=7.99 μsec

Data transfer time for partition candidate 2=24.0 μsec

Constraint time for partition candidate 2=7.80 μsec

For both the partition candidate 1 and the partition candidate 2, the data transfer time exceeds the constraint time.

For the partition candidate 1, therefore, the partition decision unit 6 notifies the transfer time evaluation unit 3 that the data transfer capacity 4.06 (=32.4 μsec/7.99 μsec) or more times as great as that of the current specified interface circuit (BUS0) is required. For the partition candidate 2, the partition decision unit 6 notifies the transfer time evaluation unit 3 that the data transfer capacity 3.08 (=24.0 μsec/7.80 μsec) or more times as great as that of the current specified interface circuit (BUS0) is required.

Subsequently, the transfer time evaluation unit 3 explores for settings that may attain the required data transfer capacity in the specified interface circuit.

As a result of exploration in relation to the partition candidate 1, the transfer time evaluation unit 3 determines that there is no setting which may increase the data transfer capacity 4.06 or more times, that is, no setting which may increase the data transfer capacity of the specified interface circuit to 10.15 Mbps (the data transfer capacity may be increased to no more than 10 Mbps even by the setting of prm1=1 and prm2=0).

In relation to the partition candidate 2, by contrast, the transfer time evaluation unit 3 determines that the setting of prm1=1 and prm2=0 makes the data transfer capacity of the specified interface circuit 10 Mbps and may consequently enable attainment of the required data transfer capacity (2.5 Mbps*3.08=7.7 Mbps).

Therefore, the transfer time evaluation unit 3 outputs the following data transfer time to the partition decision unit 6.

Data transfer time for partition candidate 1=81 bits/10 Mbps=8.1 μsec

Data transfer time for partition candidate 2=60 bits/10 Mbps=6.0 μsec

The transfer time evaluation unit 3 outputs prm1=1 and prm2=0 as interface evaluation conditions to the evaluation information output unit 8. prm1=1 and prm2=0 correspond to the alternative parameter values.

The partition decision unit 6 compares the data transfer time calculated by the transfer time evaluation unit 3, with the constraint time calculated by the constraint time calculation unit 5 afresh. Then the partition decision unit 6 determines whether the data transfer time for each partition candidate is equal to or shorter than the constraint time or not.

The data transfer time and the constraint time for the partition candidate 1 and the data transfer time and the constraint time for the partition candidate 2 are as follows.

Data transfer time for partition candidate 1=8.1 μsec

Constraint time for partition candidate 1=7.99 μsec

Data transfer time for partition candidate 2=6.0 μsec

Constraint time for partition candidate 2=7.80 μsec

In this example, the partition decision unit 6 outputs only the partition candidate 2 as the partition final candidates 12 because the data transfer time is equal to or shorter than the constraint time only for the partition candidate 2. That is, the partition decision unit 6 outputs the partition final candidates 12 as described in FIG. 6.

### Description of Effects of Embodiment

In the embodiment, the calculation formula for the data transfer capacity is prepared, correspondingly to the type of the interface circuit. In the embodiment, additionally, the transfer time evaluation unit 3 calculates the data transfer capacity of the specified interface circuit by using the calculation formula corresponding to the type of the specified interface circuit. According to the embodiment, consequently, the transfer capacity of an interface circuit can be calculated without the setting by the user for each type of the interface circuit.

In the embodiment, the evaluation information output unit 8 explores for the settings that satisfy the constraint condition and outputs the settings that satisfy the constraint condition as the evaluation information. Thus necessity for the user to explore for the interface circuit while changing setting information each time may be obviated. According to the embodiment, consequently, the hardware/software partition in consideration of the data transfer capacity may be found out efficiently.

***Description on Hardware Configuration***

Finally, supplementary description on the hardware configuration of the information processing device 1 will be given.

The processor 901 illustrated in FIG. 7 is an IC (Integrated Circuit) that carries out processing. The processor 901 is a CPU, a DSP, or the like.

The memory 902 illustrated in FIG. 7 is a RAM (Random Access Memory). The storage device 903 illustrated in FIG. 7 is a ROM (Read Only Memory), a flash memory, an HDD (Hard Disk Drive), or the like.

An OS (Operating System) is also stored in the storage device 903.

At least a portion of the OS is loaded into the memory 902 and is executed by the processor 901.

While executing at least the portion of the OS, the processor 901 executes the programs that implement the functions of the partition candidate generation unit 2, the transfer time evaluation unit 3, the arithmetic operation time calculation unit 4, the constraint time calculation unit 5, the partition decision unit 6, and the evaluation information output unit 8.

The processor 901 executes the OS, so that task management, memory management, file management, communication control, and the like are carried out.

At least any of information, data, signal values, and variable values that indicate results of processes in the partition candidate generation unit 2, the transfer time evaluation unit 3, the arithmetic operation time calculation unit 4, the constraint time calculation unit 5, the partition decision unit 6, and the evaluation information output unit 8 are stored in at least any of the memory 902, the storage device 903, and a register and a cache memory in the processor 901.

The programs that implement the functions of the partition candidate generation unit 2, the transfer time evaluation unit 3, the arithmetic operation time calculation unit 4, the constraint time calculation unit 5, the partition decision unit 6, and the evaluation information output unit 8 may be stored in a portable storage medium such as a magnetic disk, a flexible disk, an optical disk, a compact disk, a Blu-ray (a registered trademark) disk, or a DVD.

The “units” of the partition candidate generation unit 2, the transfer time evaluation unit 3, the arithmetic operation time calculation unit 4, the constraint time calculation unit 5, the partition decision unit 6, and the evaluation information output unit 8 may be read as “circuits”, “steps”, “procedures”, or “processes”.

The information processing device 1 may be implemented by an electronic circuit such as a logic IC (Integrated Circuit), a GA (Gate Array), an ASIC, or an FPGA.

In this case, the partition candidate generation unit 2, the transfer time evaluation unit 3, the arithmetic operation time calculation unit 4, the constraint time calculation unit 5, the partition decision unit 6, and the evaluation information output unit 8 are each implemented as a portion of the electronic circuit.

The processor and the electronic circuits may be collectively referred to as processing circuitry.

### REFERENCE SIGNS LIST

1: information processing device; 2: partition candidate generation unit; 3: transfer time evaluation unit; 4: arithmetic operation time calculation unit; 5: constraint time calculation unit; 6: partition decision unit; 7: database; 8: evaluation information output unit; 9: architecture information; 10: functional model; 11: constraint condition; 12: partition final candidates; 13: evaluation information

1. An information processing device comprising:
a storage device to store interface transfer capacity information in which calculation formulas for calculation of a data transfer capacity are described, correspondingly to types of interface circuits; and
processing circuitry to acquire a calculation formula corresponding to a type of a specified interface circuit which has been specified from among a plurality of interface circuits as an interface circuit to connect a plurality of arithmetic operational devices among which execution of a plurality of arithmetic operation processes is divided, from the interface transfer capacity information, and to calculate the data transfer capacity of the specified interface circuit by using the acquired calculation formula.

2. The information processing device according to claim 1, wherein
the storage device stores the interface transfer capacity information in which the calculation formulas are described, correspondingly to combinations of the types of the interface circuits and types of the arithmetic operational devices, and
the processing circuitry acquires a calculation formula corresponding to a combination of the type of the specified interface circuit and a type of an arithmetic operational device among the plurality of arithmetic operational devices, from the interface transfer capacity information.

3. The information processing device according to claim 1, wherein the processing circuitry estimates an amount of data that is transferred among the plurality of arithmetic operational devices when the execution of the plurality of arithmetic operation processes is divided among the plurality of arithmetic operational devices, and calculates data transfer time for transfer of the estimated amount of the data through the specified interface circuit, based on the data transfer capacity of the specified interface circuit calculated.

4. The information processing device according to claim 3, wherein the processing circuitry generates a plurality of division patterns of the plurality of arithmetic operation processes among the plurality of arithmetic operational devices, and
the processing circuitry estimates the amount of the data that is transferred among the plurality of arithmetic operational devices when the execution of the plurality of arithmetic operation processes is divided among the plurality of arithmetic operational devices, for each of the division patterns, and
the processing circuitry calculates the data transfer time for the transfer of the estimated amount of the data through the specified interface circuit, for each of the division patterns.

5. The information processing device according to claim 4, wherein
the processing circuitry generates the plurality of division patterns of the plurality of arithmetic operation processes among the plurality of arithmetic operational devices, through hardware/software partition.

6. The information processing device according to claim 3, wherein
the processing circuitry calculates the data transfer capacity of the specified interface circuit by applying a parameter value to the acquired calculation formula,
the processing circuitry compares the data transfer time calculated with constraint time for the data transfer, and
the processing circuitry outputs the parameter value as evaluation information when the data transfer time is equal to or shorter than the constraint time, as a result of a comparison.

7. The information processing device according to claim 6, wherein
the processing circuitry calculates the data transfer capacity of the specified interface circuit as an alternative data transfer capacity by applying an alternative parameter value that are different from the parameter value to the calculation formula when the data transfer time exceeds the constraint time, as the result of a comparison,
the processing circuitry calculates data transfer time based on the alternative data transfer capacity calculated, and
the processing circuitry compares the data transfer time calculated based on the alternative data transfer capacity with the constraint time.

8. The information processing device according to claim 4, wherein the processing circuitry unit to compares the data transfer time calculated with constraint time for the data transfer, for each of the division patterns, and outputs a division pattern whose data transfer time is equal to or shorter than the constraint time.

9. An information processing method by a computer which stores interface transfer capacity information in which calculation formulas for calculation of a data transfer capacity are described, correspondingly to types of interface circuits, the information processing method comprising:
acquiring a calculation formula corresponding to a type of a specified interface circuit which has been specified from among a plurality of interface circuits as an interface circuit to connect a plurality of arithmetic operational devices among which execution of a plurality of arithmetic operation processes is divided, from the interface transfer capacity information; and calculating the data transfer capacity of the specified interface circuit by using the acquired calculation formula.

10. A non-transitory computer readable medium storing an information processing program that causes a computer, storing interface transfer capacity information in which calculation formulas for calculation of a data transfer capacity are described, correspondingly to types of interface circuits, to execute:
a process of acquiring a calculation formula corresponding to a type of a specified interface circuit which has been specified from among a plurality of interface circuits as an interface circuit to connect a plurality of arithmetic operational devices among which execution of a plurality of arithmetic operation processes is divided, from the interface transfer capacity information; and a process of calculating the data transfer capacity of the specified interface circuit by using the acquired calculation formula.
